(19) United States
(12) Patent Application Publication
(10) Pub. No.: US 2026/0188214 A1
(43) Pub. Date: Jul. 2, 2026

(54) PIXEL DRIVING CIRCUIT, AND DISPLAY PANEL AND CONTROL METHOD THEREOF

(71) Applicants: Chengdu BOE Optoelectronics Technology Co., Ltd., Chengdu, Sichuan (CN); BOE Technology Group Co., Ltd., Beijing (CN)

(72) Inventor: Hongjun Zhou, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 18/858,817

(22) PCT Filed: Jan. 2, 2024
(86) PCT No.: PCT/CN2024/070022

§ 371 Date: Oct. 22, 2024

(30) Foreign Application Priority Data
Jan. 10, 2023 (CN) 202310038018.X

(51) Int. Cl. G09G 3/3233

(52) U.S. Cl. CPC G09G 3/3233; G09G 2300/0819; G09G 2300/0842; G09G 2300/0861; G09G 2310/0297; G09G 2310/08

(57) ABSTRACT

The present disclosure provides a pixel driving circuit, a display panel and a control method thereof, relating to a technical field of displaying. The pixel driving circuit includes a driving sub-circuit, a data temporary storage sub-circuit, a write sub-circuit, a compensation sub-circuit and a light-emitting control sub-circuit; the data temporary storage sub-circuit is connected to a first node, a data signal terminal and a first scan signal terminal; the write sub-circuit is connected to the first node, a second node and a second scan signal terminal; the driving sub-circuit is connected to the second node, a third node and a fourth node; the compensation sub-circuit is connected to the third node, the fourth node and a third scan signal terminal; and the light-emitting control sub-circuit is connected to a first voltage terminal, an enable signal terminal, the second node, the third node and a light emitting device.

This application claims the priority of the Chinese patent application filed on Jan. 10, 2023, with the application number of 202310038018.X, and the title of “pixel driving circuit, and display panel and control method thereof”, which is incorporated herein in its entirety by reference.

### TECHNICAL FIELD

The present disclosure relates to the technical field of displaying and more particularly, to a pixel driving circuit, a display panel and a control method thereof.

### BACKGROUND

There is a growing demand for display screens with narrow bezels and low power consumption in wearable devices, so data selection circuits are usually installed inside the display screens of the wearable devices. However, after setting the data selection circuits, the writing time of the data signals is significantly shortened.

### SUMMARY

Embodiments of the present disclosure provide a pixel driving circuit, a display panel and a control method thereof, to increase the writing time of the data signals.

In order to achieve the above objectives, the embodiments of the present disclosure adopt the following technical solutions:
in one aspect, the pixel driving circuit is provided, which includes a driving sub-circuit, a data temporary storage sub-circuit, a write sub-circuit, a compensation sub-circuit and a light-emitting control sub-circuit; the data temporary storage sub-circuit is connected to a first node, a data signal terminal and a first scan signal terminal, and the data temporary storage sub-circuit is configured for, in a pre-write phase, storing a data signal from the data signal terminal at the first node in response to a control signal from the first scan signal terminal; the write sub-circuit is connected to the first node, a second node and a second scan signal terminal, and the write sub-circuit is configured for, in a write phase, writing a signal of the first node to the second node in response to a control signal from the second scan signal terminal; the driving sub-circuit is connected to the second node, a third node and a fourth node, and the driving sub-circuit is configured for, under a control of a potential at the fourth node, writing a signal of the second node to the third node; the compensation sub-circuit is connected to the third node, the fourth node and a third scan signal terminal, and the compensation sub-circuit is configured for, in the write phase, writing a signal of the third node to the fourth node in response to a control signal from the third scan signal terminal; and the light-emitting control sub-circuit is connected to a first voltage terminal, an enable signal terminal, the second node, the third node and a light emitting device, and the light-emitting control sub-circuit is configured for, in a luminous phase, cooperating with the driving sub-circuit to drive the light emitting device to emit light in response to an enable signal from the enable signal terminal.

In some embodiments, the data temporary storage sub-circuit includes a first transistor and a first capacitor; a gate of the first transistor is connected to the first scan signal terminal, a first electrode of the first transistor is connected to the data signal terminal, and a second electrode of the first transistor is connected to the first node; and a first electrode plate of the first capacitor is connected to the first node.

In some embodiments, a second electrode plate of the first capacitor is connected to the first voltage terminal.

In some embodiments, the pixel driving circuit further includes a storage sub-circuit, the storage sub-circuit is connected to the first voltage terminal and the fourth node, and the storage sub-circuit is configured for storing a signal of the fourth node.

In some embodiments, the storage sub-circuit includes a second capacitor, a first electrode plate of the second capacitor is connected to the fourth node, a second electrode plate of the second capacitor is connected to the first voltage terminal.

In some embodiments, the driving sub-circuit includes a driving transistor, a first electrode of the driving transistor is connected to the second node, a second electrode of the driving transistor is connected to the third node, and a gate of the driving transistor is connected to the fourth node.

In some embodiments, the write sub-circuit includes a second transistor, a first electrode of the second transistor is connected to the first node, a second electrode of the second transistor is connected to the second node, and a gate of the second transistor is connected to the second scan signal terminal.

In some embodiments, the compensation sub-circuit includes a third transistor, a first electrode of the third transistor is connected to the third node, a second electrode of the third transistor is connected to the fourth node, and a gate of the third transistor is connected to the third scan signal terminal.

In some embodiments, the light-emitting control sub-circuit includes a fourth transistor and a fifth transistor;
a first electrode of the fourth transistor is connected to the first voltage terminal, a second electrode of the fourth transistor is connected to the second node, and a gate of the fourth transistor is connected to the enable signal terminal; and a first electrode of the fifth transistor is connected to the third node, a second electrode of the fifth transistor is connected to an anode of the light emitting device, and a gate of the fifth transistor is connected to the enable signal terminal.

In some embodiments, the pixel driving circuit further includes a first reset sub-circuit, the first reset sub-circuit is connected to the fourth node, a first reset signal terminal and a fourth scan signal terminal, and the first reset sub-circuit is configured for writing a signal of the first reset signal terminal to the fourth node in response to a control signal from the fourth scan signal terminal.

In some embodiments, the first reset sub-circuit includes a sixth transistor, a first electrode of the sixth transistor is connected to the first reset signal terminal, a second electrode of the sixth transistor is connected to the fourth node, and a gate of the sixth transistor is connected to the fourth scan signal terminal.

In some embodiments, the pixel driving circuit further includes a second reset sub-circuit, the second reset sub-circuit is connected to an anode of the light emitting device, a second reset signal terminal and a fifth scan signal terminal, and the second reset sub-circuit is configured for writing a signal of the second reset signal terminal to the light emitting device in response to a control signal from the fifth scan signal terminal.

In some embodiments, the second reset sub-circuit includes a seventh transistor, a first electrode of the seventh transistor is connected to the second reset signal terminal, a second electrode of the seventh transistor is connected to a second electrode of the light emitting device, and a gate of the seventh transistor is connected to the fifth scan signal terminal.

In another aspect, a display panel is provided, which includes a substrate, a plurality of pixel driving circuits according to any one of the above embodiments that are disposed on the substrate, and a light emitting device connected to the plurality of pixel driving circuits; the plurality of pixel driving circuits includes a first pixel driving circuit and a second pixel driving circuit, and the display panel further includes a first terminal, a first data selection circuit, a second data selection circuit, a first data line and a second data line; the first terminal is connected to the first data selection circuit and the second data selection circuit, the first data selection circuit is connected to the first data line, the second data selection circuit is connected to the second data line, the first data line is connected to a data signal terminal of the first pixel driving circuit, and the second data line is connected to a data signal terminal of the second pixel driving circuit.

In yet another aspect, a control method of a display panel is provided, for controlling the above display panel, one luminous period of the light emitting device includes the pre-write phase, the write phase and the luminous phase, the pre-write phase includes a first phase and a second phase, and the method includes:
in the first phase, providing a first data signal to the first terminal, controlling the first data selection circuit to turn on, controlling the second data selection circuit to turn off, and providing a control signal to the first scan signal terminal of the first pixel driving circuit, to write the first data signal to the first node in the first pixel driving circuit;
in the second phase, providing a second data signal to the first terminal, controlling the second data selection circuit to turn on, controlling the first data selection circuit to turn off, and providing a control signal to the first scan signal terminal of the second pixel driving circuit, to write the second data signal to the first node in the second pixel driving circuit;
in the write phase, providing control signals to the second scan signal terminal and the third scan signal terminal, respectively, to sequentially write data signals stored in the first node to the second node, the third node and the fourth node; and
in the luminous phase, providing an enable signal to the enable signal terminal, so that the light-emitting control sub-circuit cooperates with the driving sub-circuit, to drive the light emitting device to emit light.

In the pixel driving circuit and display panel provided in the embodiments of the present disclosure, the light emitting device connected to the first pixel driving circuit is the first light emitting device, and the light emitting device connected to the second pixel driving circuit is the second light emitting device. When controlling the first light emitting device and the second light emitting device to emit light, the first data selection circuit for writing data signals to the first pixel driving circuit and the second data selection circuit for writing data signals to the second pixel driving circuit are turned on within one frame range, while the write sub-circuits in the first pixel driving circuit and the second pixel driving circuit conduct within another frame range. That is, the turn-on of the data selection circuit and the conduction of the write sub-circuit are in two different frames, respectively. Compared to the solution in the related art that the turn-on of the data selection circuit and the conduction of the write sub-circuit are in the same frame range, the turn-on time of the data selection circuit and the conduction time of the write sub-circuit are significantly increased in the present disclosure.

The above description is merely a summary of the technical solutions of the present disclosure. In order to more clearly know the technical means of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the related art, the figures that are required to describe the embodiments or the related art will be briefly described below. Apparently, the figures that are described below are embodiments of the present disclosure, and a person skilled in the art can obtain other figures according to these figures without paying creative work.

FIG. 1 is a schematic structural diagram of a display device according to the present disclosure;

FIG. 2 is a schematic structural diagram of a display panel according to the present disclosure;

FIG. 3 is a circuit schematic diagram of a display panel in related art;

FIG. 4 is a circuit schematic diagram of a pixel driving circuit in related art;

FIG. 5 is a timing diagram of the control signals in FIG. 3 and FIG. 4;

FIG. 6 is a circuit schematic diagram of a display panel according to the present disclosure;

FIG. 7 is a schematic structural diagram of a pixel driving circuit according to the present disclosure;

FIG. 8 is a timing diagram of the control signals in FIG. 6 and FIG. 7;

FIG. 9 to FIG. 13 are schematic structural diagrams of pixel driving circuits according to the present disclosure; and

FIG. 14 is a flow chart of a control method of a display panel disclosed according to the present disclosure.

### DETAILED DESCRIPTION

In order to make the purpose, technical solution, and advantages of the embodiment of the present disclosure clearer, the technical solutions according to the embodiments of the present disclosure will be clearly and completely described below with reference to the drawings. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

In the circuit structure provided in the embodiments of the present disclosure (e.g. the pixel driving circuit), the transistors used in the circuit structure can be a thin film transistor (TFT), a metal oxide semiconductor (MOS), or other specific and similar switching devices. The embodiments of the present disclosure are all illustrated by taking the thin film transistor as an example.

In the circuit structure provided in the embodiments of the present disclosure, the first electrode of each transistor used is one of the source and drain, and the second electrode of each transistor is the other of the source and drain. Since the structure of the source and the structure of the drain of one transistor may be symmetrical, there may be no difference in the structures of the source and drain. For example, when the transistor is a P-type transistor, the first electrode of the transistor is the source and the second electrode is the drain; when the transistor is an N-type transistor, the first electrode of the transistor is the drain and the second electrode is the source.

In the circuit structure provided in the embodiments of the present disclosure, the first node, the second node, the third node, the fourth node, and other nodes do not represent actual components, but rather represent the junction points of relevant connections in the circuit diagram. In other words, these nodes are equivalently formed from the junction points of relevant connections in the circuit diagram.

The transistors included in the circuit structure provided in the embodiments of the present disclosure may all be N-type transistors, or they may all be P-type transistors, or some of them may be N-type transistors and the other of them may be P-type transistors. In the present disclosure, “effective level” refers to the level at which the transistor can conduct. Among them, the P-type transistor can conduct under the control of low-level signals, while the N-type transistor can conduct under the control of high-level signals.

The embodiment of the present disclosure provides a display device, which can be a device with a display panel, such as a mobile phone, a laptop, an ultra-mobile personal computer (UMPC), a netbook, a personal digital assistant (PDA), a wearable device, a virtual reality device or a mobile computing device, which is not limited in the embodiment of the present disclosure. For the convenience of description, the present disclosure takes the display device being a smart watch as an example to illustrate.

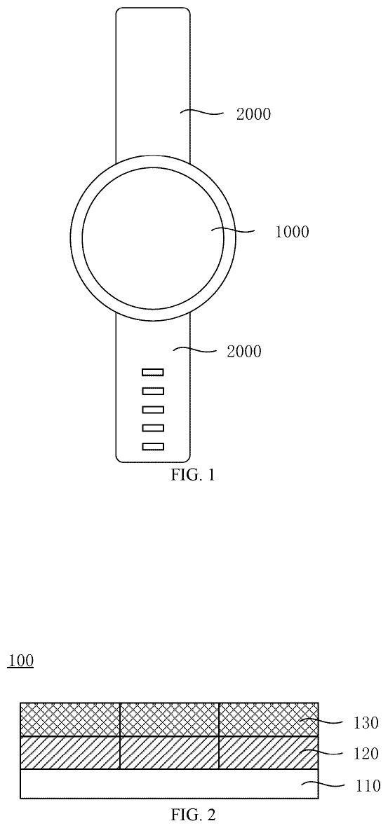

FIG. 1 is a schematic structural diagram of the display device provided in an embodiment of the present disclosure. As shown in FIG. 1, the display device may include a main body 1000 and a watch strap 2000. The main body 1000 serves as the main structure of the display device, and is used to achieve the main functions (such as communication, exercise monitoring, health monitoring, etc.) of the display device. The watch strap 2000 is connected to the main body 1000, and is used to detachable wear the main body 1000 on the wrist of the user. For example, as shown in FIG. 1, the display device includes two watch straps 2000, one watch strap 2000 is connected to the upper side of the main body 1000, and the other watch strap 2000 is connected to the lower side of the main body 1000. When worn, the two watch straps 2000 surround the wrist of the user and are connected through a buckle structure (not shown in the figure). It can be understood that in the actual application process, the main body can also be worn on the wrist of the user in other ways, and which is not limited in the embodiment of the present disclosure.

The main body 1000 is provided with a display panel 100, which can display images and present information to users through the displayed images. For example, the display panel 100 displays images to show users call states, exercise monitoring data, health monitoring data, and so on of the display device. The image displayed on display panel 100 can be either a static image or a dynamic image, and the content of the image can be text, images, or both the text and the images.

The display panel 100 can be an electroluminescent display panel or a photoluminescent display panel. When the display panel 100 is the electroluminescent display panel, the electroluminescent display panel can be an organic light-emitting diode (OLED) display panel, a quantum dot light emitting diode (QLED) display panel, or an active-matrix organic light emitting diode (AMOLED) display panel. The organic light-emitting diode display panels have been widely used in the display field due to their advantages such as self-emission, a low driving voltage, a high luminous efficiency, a fast response speed, and flexible display. Therefore, in the embodiments of the present disclosure, only the display panel 100 being an OLED display panel is used as an example for illustration.

FIG. 2 is a schematic structural diagram of a display panel according to the present disclosure. As shown in FIG. 2, the display panel 100 includes a substrate 110, a plurality of pixel driving circuits 120 that are disposed on one side of the substrate 110, and a plurality of light emitting devices 130 disposed on a side of the plurality of pixel driving circuits 120 away from the substrate 110. The pixel driving circuits 120 are connected to the light emitting devices 130.

For example, the substrate 110 may be a flexible substrate or a rigid substrate.

For example, when the substrate 110 is the flexible substrate, the material of the substrate 110 can be high elasticity materials such as dimethyl siloxane, Polyimide (PI), Polyethylene Terephthalate (PET), etc.

For example, when the substrate 110 is the rigid substrate, the material of the substrate 110 can be glass or the like.

In some examples, the plurality of pixel driving circuits 120 and the plurality of light emitting devices 130 can correspond and be connected one by one. In other examples, one pixel driving circuit 120 may be connected to the plurality of light emitting devices 130, or the plurality of pixel driving circuits 120 may be connected to one light emitting device 130. The embodiment of the present disclosure only takes the connection of one pixel driving circuit 120 and one light emitting device 130 as an example to illustrate the structure of the display panel 100.

One pixel driving circuit 120 is connected to one light emitting device 130 to form a pixel. The display panel 100 is provided with a plurality of pixels, which can be arranged in an array to form a plurality of pixel rows and a plurality of pixel columns. Each pixel column corresponds to one data line, the data line is connected to the pixel driving circuit in this pixel column to provide data signals to the pixel driving circuit in the pixel column.

In order to reduce the frame and power consumption of the display panel 100, there is also a data selection circuit (Multiplexer, referred to as MUX) inside the display panel 100, and the data lines are connected to the driver chip through the data selection circuit. The selection ratio of the data selection circuit can be 1:6, 1:9, 1:12, etc., and which is not limited in the embodiment of the present disclosure.

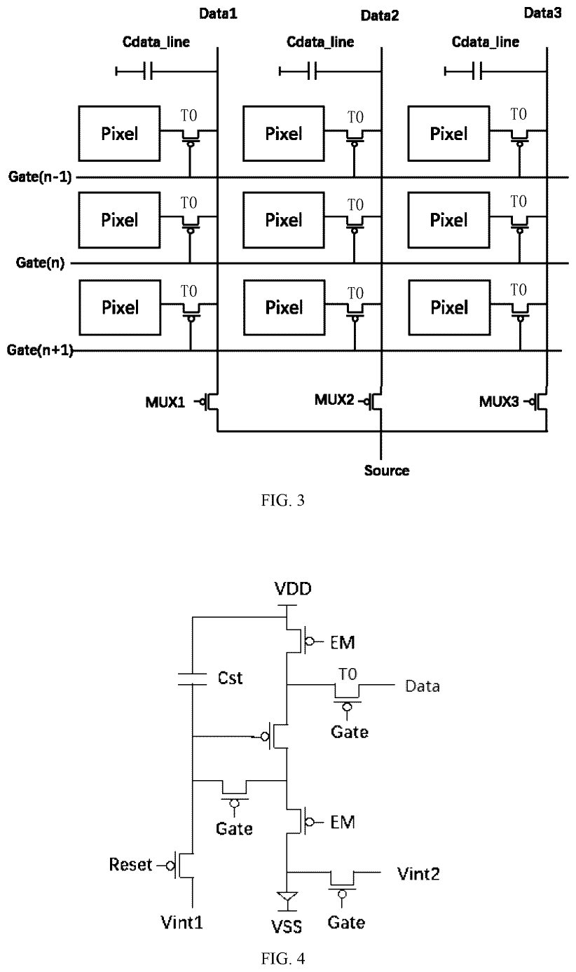

FIG. 3 is a circuit schematic diagram of a display panel in related art, and FIG. 4 is a circuit schematic diagram of a pixel driving circuit in related art. The box marked with Pixel in FIG. 3 represents the part of the pixel driving circuit in FIG. 4 except for the T0 transistor. Data1, Data2, and Data3 represent three data lines, MUX1, MUX2, and MUX3 represent three data selection circuits, Source represents the data signal from the driver chip, Cdata_line represents the parasitic capacitor, and Gate(n−1), Gate(n), and Gate(n+1) represent three gating lines, respectively. Among them, the TO transistors in FIG. 3 and FIG. 4 are the same transistor. FIG. 5 is a timing diagram of the control signals in FIG. 3 and FIG. 4. The area between two adjacent vertical dashed lines in the figure represents one frame.

As shown in FIG. 3 to FIG. 5, the working process of the display panel in related art is as follows.

In a S1 phase:
MUX1 is turned on, while MUX2 and MUX3 are turned off, and T0 is turned off. The data signal output by the driver chip is written into the parasitic capacitor Cdata_line connected to Data1 through Data1;
MUX2 is turned on, while MUX1 and MUX3 are turned off, and T0 is turned off. The data signal output by the driver chip is written into the parasitic capacitor Cdata_line connected to Data2 through Data2; and
MUX3 is turned on, while MUX1 and MUX2 are turned off, and T0 is turned off. The data signal output by the driver chip is written into the parasitic capacitor Cdata_line connected to Data3 through Data3.

At this point, the parasitic capacitor Cdata line connected to Data1, the parasitic capacitor Cdata_line connected to Data2, and the parasitic capacitor Cdata_line connected to Data3 are all written into the data signal.

In a S2 phase:
MUX1, MUX2, and MUX3 are all turned off, and an effective level is input to one of the gating lines Gate (n), so that the three T0 transistors connected to Gate(n) is turned on, thereby writing the data signals stored in the three parasitic capacitors Cdata_line into the corresponding pixel driving circuits, and driving the light emitting device to emit light corresponding to the data signals.

However, as shown in FIG. 5, the turn-on phase (S1 phase) of the three data selection circuits MUX and the turn-on phase (S2 phase) of the T0 transistor are both completed within one frame time range, resulting in a shorter turn-on time of the T0 transistor, that is, a shorter time for data signal writing and compensation. Moreover, within a certain frame time range, the larger the selection ratio of the data selection circuit (1:6, 1:9, 1:12 increasing sequentially), the shorter the turn-on time of the TO transistor.

On the other hand, when the shape of the display panel 100 is a non-rectangular shape such as a circle, the lengths of different pixel columns are different, resulting in different parasitic capacitance values of the parasitic capacitors Cdata_line formed by different pixel columns. To ensure that the capacitance values of the parasitic capacitors Cdata_line formed by different pixel columns are the same, it is necessary to compensate for the capacitance of Cdata line.

In view of this, the display panel provided in the embodiments of the present disclosure no longer uses the parasitic capacitors to store data signals, solving the problem of short time for the data signal writing and compensation. Moreover, since the parasitic capacitors are not required, there is no need to compensate for the capacitance values of the parasitic capacitors.

The display panel provided in this embodiment of the present disclosure includes a first terminal, a first data selection circuit, a second data selection circuit, a first data line, and a second data line.

The driver chip used to drive the display panel is provided with a plurality of output ports, each output port can output data signals. Correspondingly, the display panel includes a plurality of terminals. After the driver chip is bound to the display panel, the plurality of output ports correspond one-to-one with the plurality of terminals and are electrically connected, so that the display panel receives the data signals from the driver chip through the terminals. The first terminal is one of the plurality of terminals.

The first terminal is connected to the first data selection circuit and the second data selection circuit, the first data selection circuit is connected to the first data line, and the second data selection circuit is connected to the second data line. The plurality of pixel driving circuits include a first pixel driving circuit and a second pixel driving circuit, the first data line is connected to the data signal terminal of the first pixel driving circuit, and the second data line is connected to the data signal terminal of the second pixel driving circuit.

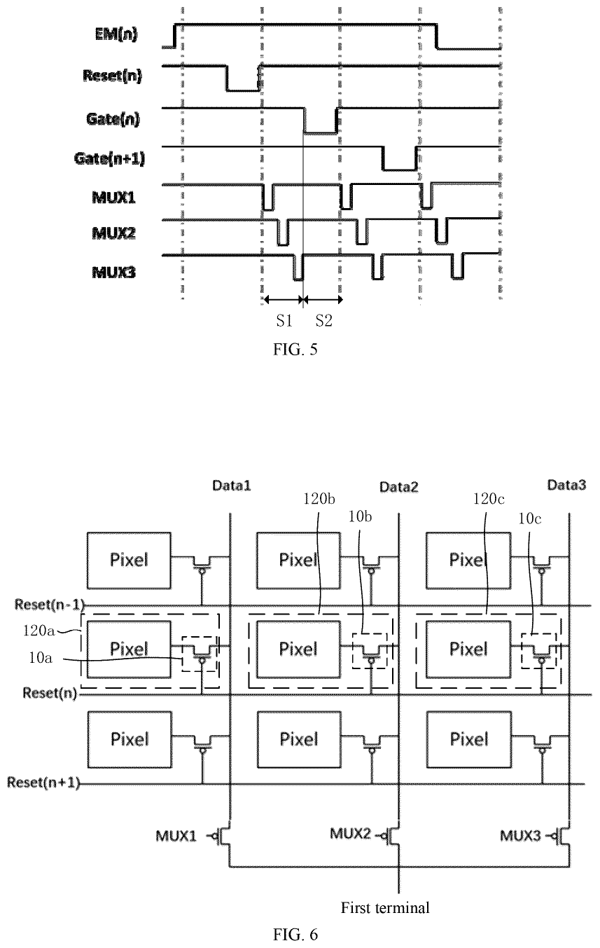

FIG. 6 is a circuit schematic diagram of a display panel according to an embodiment of the present disclosure.

For example, as shown in FIG. 6, the display panel includes a first pixel driving circuit 120a, a second pixel driving circuit 120b, a third pixel driving circuit 120c, a first data line Data1, a second data line Data2, a third data line Data3, a first data selection circuit MUX1, a second data selection circuit MUX2, and a third data selection circuit MUX3. Among them, the first terminal is connected to the first pixel driving circuit 120a through the first data selection circuit MUX1 and the first data line Data1, the first terminal is connected to the second pixel driving circuit 120b through the second data selection circuit MUX2 and the second data line Data2, and the first terminal is connected to the third pixel driving circuit 120c through the third data selection circuit MUX3 and the third data line Data3.

It should be noted that the above only uses the selection ratio of the data selection circuits as 1:3, and the display panel 100 only including the first terminal as an example for explanation. In practical applications, the selection ratio of the data selection circuits can be 1:6, 1:9, 1:12, etc., and the display panel can also include the second terminal, the third terminal, etc.

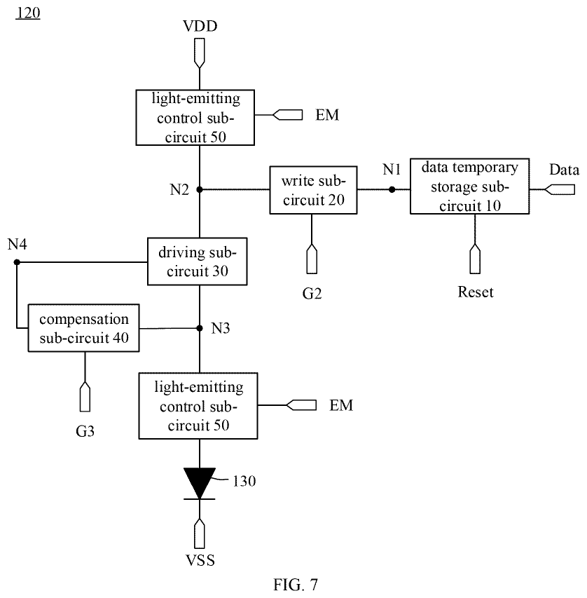

FIG. 7 is a schematic structural diagram of a pixel driving circuit according to an embodiment of the present disclosure.

As shown in FIG. 7, the pixel driving circuit includes a driving sub-circuit 30, a data temporary storage sub-circuit 10, a write sub-circuit 20, a compensation sub-circuit 40 and a light-emitting control sub-circuit 50.

The data temporary storage sub-circuit 10 is connected to a first node N1, a data signal terminal Data and a first scan signal terminal Reset. The data temporary storage sub-circuit 10 is configured for, in a pre-write phase, storing a data signal from the data signal terminal Data at the first node N1 in response to a control signal from the first scan signal terminal Reset.

The write sub-circuit 20 is connected to the first node N1, a second node N2 and a second scan signal terminal G2. The write sub-circuit 20 is configured for, in a write phase, writing a signal of the first node N1 to the second node N2 in response to a control signal from the second scan signal terminal G2.

The driving sub-circuit 30 is connected to the second node N2, a third node N3 and a fourth node N4. The driving sub-circuit 30 is configured for, under a control of a potential at the fourth node N4, writing a signal of the second node N2 to the third node N3.

The compensation sub-circuit 40 is connected to the third node N3, the fourth node N4 and a third scan signal terminal G3. The compensation sub-circuit 40 is configured for, in the write phase, writing a signal of the third node N3 to the fourth node N4 in response to a control signal from the third scan signal terminal G3.

The light-emitting control sub-circuit 50 is connected to a first voltage terminal VDD, an enable signal terminal EM, the second node N2, the third node N3 and a light emitting device. The light-emitting control sub-circuit 50 is configured for, in a luminous phase, cooperating with the driving sub-circuit 30 to transmit driving signals to the light emitting device in response to an enable signal from the enable signal terminal EM.

The working process of the pixel driving circuit is as follows.

In the pre-write phase, the data temporary storage sub-circuit 10 writes and stores the data signal from the data signal terminal Data in the data temporary storage sub-circuit 10 in response to the control signal received by the first scan signal terminal Reset.

In the write phase, the write sub-circuit 20 writes the data signal stored in the data temporary storage sub-circuit 10 to the second node N2 in response to the control signal of the second scan signal terminal G2. The data signal is converted into a compensation signal after passing through the driving sub-circuit 30. The compensation signal is transmitted to the fourth node N4 through the compensation sub-circuit 40, that is, completing the writing of the compensation signal, which compensates for the threshold voltage of the driving sub-circuit 30.

In the luminous phase, the light-emitting control sub-circuit 50, in response to the enable signal from the enable signal terminal EM, cooperates with the driving sub-circuit 30 to transmit the first potential provided by the first voltage terminal VDD sequentially passing through the second node N2 and the third node N3 to the first electrode of the light emitting device, thereby cooperating with the second potential provided by the second voltage terminal VSS on the second electrode of the light emitting device, to drive the light emitting device to emit light.

It should be noted that the box area marked with Pixel in FIG. 6 represents the part of the pixel driving circuit shown in FIG. 7 except for the data temporary storage sub-circuit 10. The data temporary sub-circuit in the first pixel driving circuit 120a in FIG. 6 is the first data temporary sub-circuit 10a, the data temporary sub-circuit in the second pixel driving circuit 120b is the second data temporary sub-circuit 10b, and the data temporary sub-circuit in the third pixel driving circuit 120c is the third data temporary sub-circuit 10c. The structures of the three data temporary sub-circuits may be the same.

In addition, the control signals received by the first scan signal terminals Reset in the first data temporary sub-circuit 10a, the second data temporary sub-circuit 10b, and the third data temporary sub-circuit 10c can be the same or different. For example, as shown in FIG. 6, the first scan signal terminals Reset of the three temporary sub-circuits are all connected to the Reset(n) line, which receives the same control signal.

For example, as shown in FIG. 6, the display panel includes the plurality of pixel driving circuit rows and the plurality of pixel driving circuit columns. The first pixel driving circuit 120a, the second pixel driving circuit 120b, and the third pixel driving circuit 120c are located in the same pixel driving circuit row but in different pixel driving circuit column. A data line (Data1, Data2, or Data3) is connected to one column of pixel drive circuits, and a gating line [Reset(n−1), Reset(n), or Reset(n+1)] is connected to one row of pixel drive circuits.

For example, the display panel includes a column of the first pixel driving circuits 120a, a column of the second pixel driving circuits 120b, and a column of the third pixel driving circuits 120c. The first data line Data1 is connected to the data signal terminal Data of the data temporary storage sub-circuit 10 in the column of the first pixel driving circuits 120a, the second data line Data2 is connected to the data signal terminal Data of the data temporary storage sub-circuit 10 in the column of the second pixel driving circuits 120b, and the third data line Data3 is connected to the data signal terminal Data of the data temporary storage sub-circuit 10 in the column of the third pixel driving circuits 120c. The first terminal is connected to the first data line Data1 through the first data selection circuit MUX1, the first terminal is connected to the second data line Data2 through the second data selection circuit MUX2, and the first terminal is connected to the third data line Data3 through the third data selection circuit MUX3.

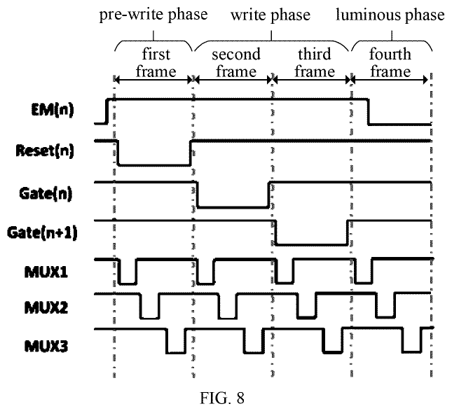

FIG. 8 is a timing diagram of the control signals in FIG. 6 and FIG. 7. The area between two adjacent vertical dashed lines in FIG. 8 is one frame. For example, as shown in FIG. 6 to FIG. 8, the working process of the display panel is as follows.

Within the first frame range:
MUX1 is turned on, while MUX2 and MUX3 are turned off. Reset(n) receives a valid level input, so that the first scan signal terminal Reset of the first data temporary storage sub-circuit 10a connected to Reset(n) and Data1 receives the valid level. This allows the data signal received by the first terminal to pass through the first data selection circuit MUX1 and the first data line Data1, and be written and stored in the first data temporary storage sub-circuit 10a connected to Reset(n) and Data1;
MUX2 is turned on, while MUX1 and MUX3 are turned off. Reset(n) receives a control signal, so that the first scan signal terminal Reset of the second data temporary storage sub-circuit 10b connected to Reset(n) and Data2 receives the valid level. This allows the data signal received by the first terminal to pass through the second data selection circuit MUX2 and the second data line Data2, and be written and stored in the second data temporary storage sub-circuit 10b connected to Reset(n) and Data2;
MUX3 is turned on, while MUX1 and MUX2 are turned off. Reset(n) receives a control signal, so that the first scan signal terminal Reset of the third data temporary storage sub-circuit 10c connected to Reset(n) and Data3 receives the valid level. This allows the data signal received by the first terminal to pass through the third data selection circuit MUX3 and the third data line Data3, and be written and stored in the third data temporary storage sub-circuit 10c connected to Reset(n) and Data3.

At this time, all of the first data temporary storage sub-circuit 10a, the second data temporary storage sub-circuit 10b, and the third data temporary storage sub-circuit 10c store the data signals.

Within the second frame range:
Reset(n) receives an invalid level input, while Gate (n) receives a valid level input, so that the data temporary storage sub-circuit 10, which stores the data signal in the range of the first frame, writes the data signal to the second node N2 through the write sub-circuit 20.

Within the third frame range:
the data signal of the second node N2 is converted into a compensation signal after passing through the driving sub-circuit 30. The compensation signal is transmitted to the fourth node N4 through the compensation sub-circuit 40, which completes the writing of the compensation signal and compensates for the threshold voltage of the driving sub-circuit 30.

Within the fourth frame range:
the enable signal terminal EM receives a valid level input, so that the light-emitting control sub-circuit 50 cooperates with the driving sub-circuit 30 to transmit the first potential provided by the first voltage terminal VDD sequentially passing through the second node N2 and the third node N3 to the first electrode of the light emitting device, thereby cooperating with the second potential provided by the second voltage terminal VSS on the second electrode of the light emitting device, to drive the light emitting device to emit light.

One luminous period of the light emitting device includes the pre-write phase, the write phase and the luminous phase. For example, the pre-write phase may include the first frame in FIG. 8, the write phase may include the second frame and the third frame in FIG. 8, and the luminous phase may include the fourth frame in FIG. 8.

Among them, the pre-write phase can be divided into a plurality of phases according to the number of data selection circuits that are turned on during the pre-write phase. For example, if there are two data selection circuits turned on during the pre-write phase, the pre-write phase can include the first phase and the second phase. If there are three data selection circuits turned on during the pre-write phase, the pre-write phase can include the first phase, the second phase, and the third phase, and so on.

The light emitting device connected to the first pixel driving circuit 120a is the first light emitting device, and the light emitting device connected to the second pixel driving circuit 120b is the second light emitting device. From FIG. 7 and FIG. 8, it can be seen that for the display panel provided in the embodiments of the present disclosure, when controlling the first light emitting device and the second light emitting device to emit light, the first data selection circuit for writing the data signals to the first pixel driving circuit 120a and the second data selection circuit for writing the data signals to the second pixel driving circuit 120b are turned on within one frame range, while the write sub-circuits 20 in the first pixel driving circuit 120a and the second pixel driving circuit 120b conduct within another frame range. That is, the turn-on of the data selection circuit and the conduction of the write sub-circuit are in two different frames, respectively. Compared to the solution in the related art that the turn-on of the data selection circuit and the conduction of the write sub-circuit are in the same frame range, the turn-on time of the data selection circuit and the conduction time of the write sub-circuit are significantly increased in the present disclosure.

For example, as shown in FIG. 8, the sum of the turn-on times of the three data selection circuits is close to one frame time, and the conduction time of the write sub-circuit 20 is also close to one frame time.

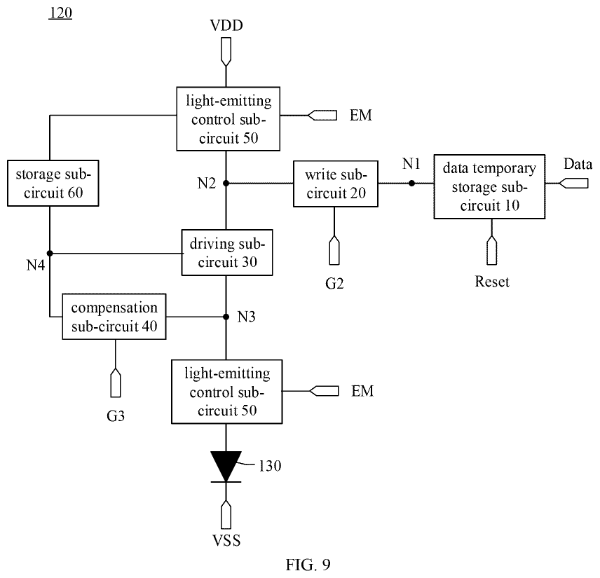

As shown in FIG. 9, the pixel driving circuit may further include a storage sub-circuit 60, the storage sub-circuit 60 is connected to the first voltage terminal VDD and the fourth node N4. The storage sub-circuit 60 is configured to store the signal of the fourth node N4.

Under the control of the control signal transmitted from the second scan signal terminal G2, the write sub-circuit 20 conducts, and at this time, the data signal of the first node N1 is transmitted to the second node N2. The driving sub-circuit 30 conducts, and the compensation sub-circuit 40 conducts under the control of the control signal received by the third scan signal terminal G3, so that the signal of the second node N2 is written to the fourth node N4 through the third node N3 and stored in the storage sub-circuit 60.

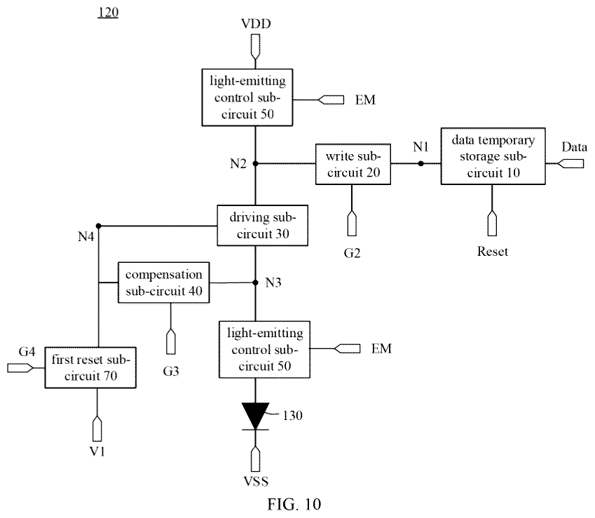

As shown in FIG. 10, the pixel driving circuit further includes a first reset sub-circuit 70, the first reset sub-circuit 70 is connected to the fourth node N4, a first reset signal terminal VI and a fourth scan signal terminal G4. The first reset sub-circuit 70 is configured for writing a signal of the first reset signal terminal V1 to the fourth node N4 in response to a control signal from the fourth scan signal terminal G4.

The first reset sub-circuit 70 conducts under the control of the control signal received by the fourth scan signal terminal G4, and transmits the first reset signal received at the first reset signal terminal V1 to the fourth node N4, to reset the fourth node N4. To stabilize the transistors in the driving sub-circuit 30 in the initial state before the write phase, which facilitates the transistors in the driving sub-circuit 30 to remain in the stable state during the write phase, and greatly improves the hysteresis effect of the transistors in the driving sub-circuit 30.

Among them, the first reset sub-circuit 70 can conduct during the pre-write phase. For example, the control signals received by the first scan signal terminal Reset and the fourth scan signal terminal G4 are synchronized, that is, the data temporary storage sub-circuit 10 and the first reset sub-circuit 70 conduct simultaneously. Certainly, the control signals received by the first scan signal terminal Reset and the fourth scan signal terminal G4 can also be asynchronous. For example, the first scan signal terminal Reset receives the Reset signal of the nth row of pixels, i.e. Reset(n), while the fourth scan signal terminal G4 receives the Reset signal of the (n−1)th row of pixels, i.e. Reset(n−1).

In some examples, the first reset sub-circuit 70 can be used to reset the fourth node N4 multiple times, which is more conducive to ensuring the stability of the voltage of the fourth node N4. The embodiment of the present disclosure does not limit the number of resets for the fourth node N4, which can be 1, 2, or 3 times.

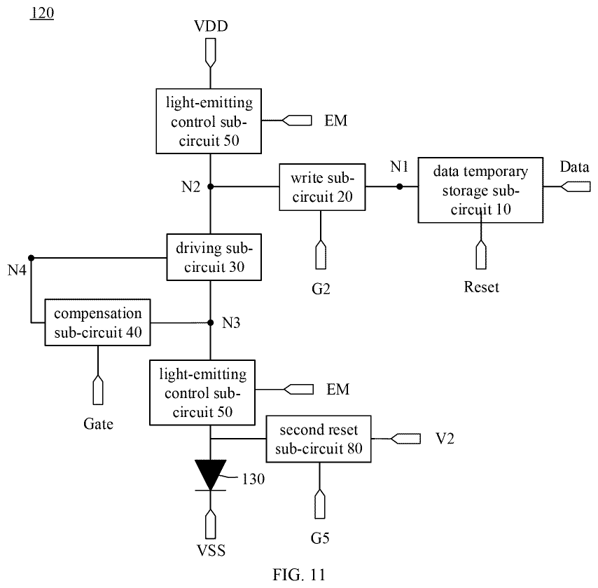

As shown in FIG. 11, in some embodiments, the pixel driving circuit further includes a second reset sub-circuit 80, the second reset sub-circuit 80 is connected to an anode of the light emitting device, a second reset signal terminal V2 and a fifth scan signal terminal G5, and the second reset sub-circuit 80 is configured for writing a signal of the second reset signal terminal V2 to the anode of the light emitting device in response to a control signal from the fifth scan signal terminal G5.

The second reset sub-circuit 80 conducts under the control of the control signal received from the fifth scan signal terminal G5, and transmits the second reset signal received at the second reset signal terminal V2 to the light emitting device, to reset the anode of the light emitting device, and to improve the stability of the light emitting device.

Among them, the second reset sub-circuit 80 can conduct during the write phase or during the pre-write phase.

For example, the control signal received by the fifth scan signal terminal G5 can be synchronized with the control signal received by the second scan signal terminal G2.

For example, the control signal received by the fifth scan signal terminal G5 can be synchronized with the control signal received by the first scan signal terminal Reset.

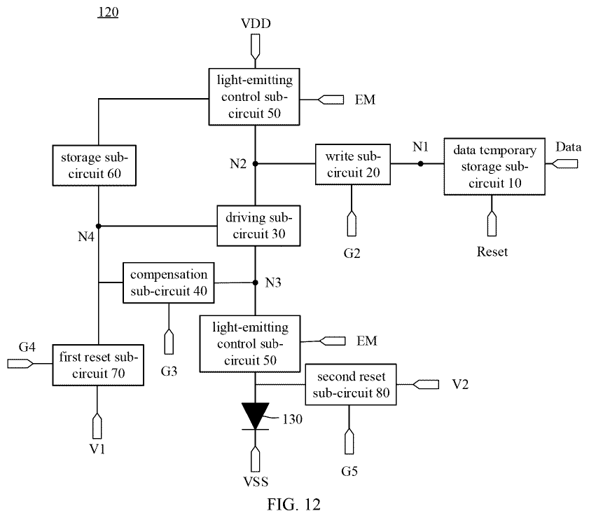

As shown in FIG. 12, in some embodiments, the pixel driving circuit may simultaneously include the storage sub-circuit 60, the first reset sub-circuit 70, and the second reset sub-circuit 80.

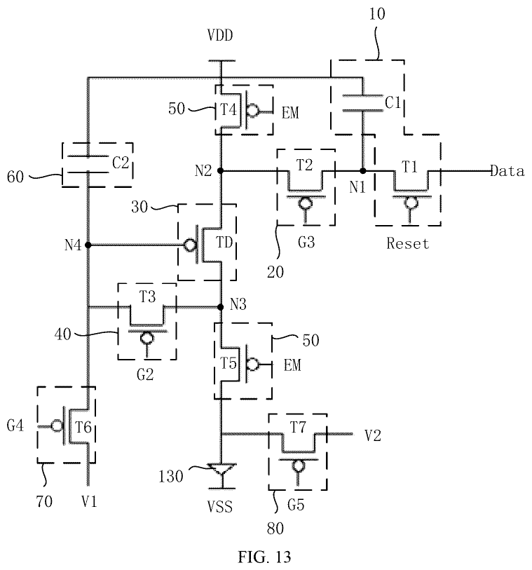

As shown in FIG. 13, in some embodiments, the data temporary storage sub-circuit 10 includes a first transistor T1 and a first capacitor C1. A gate of the first transistor T1 is connected to the first scan signal terminal Reset, a first electrode of the first transistor T1 is connected to the data signal terminal Data, and a second electrode of the first transistor T1 is connected to the first node N1. A first electrode plate of the first capacitor C1 is connected to the first node N1.

In the pre-write phase, the first transistor T1 conducts under the control of the control signal received at the first scan signal terminal Reset, so that the data signal from the data signal terminal Data is written to the first node N1 passing through the first electrode and the second electrode of the first transistor T1, to make the first capacitor C1 be charged, thus storing the data signal in the capacitor.

The second electrode plate of the first capacitor C1 can be connected to the first voltage terminal VDD. Certainly, the second electrode plate can also be connected to other voltage terminals, as long as it can ensure that the first capacitor C1 can store the data signals. When the second electrode plate is connected to the first voltage terminal VDD, there is no need to set up an additional wiring to connect the second electrode plate, simplifying the structure of the pixel driving circuit.

The storage sub-circuit 60 includes a second capacitor C2, a first electrode plate of the second capacitor C2 is connected to the fourth node N4, a second electrode plate of the second capacitor C2 is connected to the first voltage terminal VDD.

In the data writing phase, the write sub-circuit 20, the driving sub-circuit 30, and the compensation sub-circuit 40 conduct, and charge movement occurs between the first electrode plate of the first capacitor C1 and the first electrode plate of the second capacitor C2, causing the potential of the first electrode plate of the second capacitor C2 to rise. When the potential difference between the first electrode plate of the second capacitor C2 and the first electrode plate of the first capacitor C1 is equal to the threshold voltage of the driving transistor TD, the driving transistor TD is turned off, and there is no charge movement between the first capacitor C1 and the second capacitor C2, thus completing the compensation of the threshold voltage.

The driving sub-circuit 30 includes a driving transistor TD, a first electrode of the driving transistor TD is connected to the second node N2, a second electrode of the driving transistor TD is connected to the third node N3, and a gate of the driving transistor TD is connected to the fourth node N4.

The write sub-circuit 20 includes a second transistor T2, a first electrode of the second transistor T2 is connected to the first node N1, a second electrode of the second transistor T2 is connected to the second node N2, and a gate of the second transistor T2 is connected to the second scan signal terminal G2.

The compensation sub-circuit 40 includes a third transistor T3, a first electrode of the third transistor T3 is connected to the third node, N3 a second electrode of the third transistor T3 is connected to the fourth node N4, and a gate of the third transistor T3 is connected to the third scan signal terminal G3.

Among them, the control signal received by the second scan signal terminal G2 can be synchronized with the control signal received by the third scan signal terminal G3.

The light-emitting control sub-circuit 50 includes a fourth transistor T4 and a fifth transistor T5. A first electrode of the fourth transistor T4 is connected to the first voltage terminal VDD, a second electrode of the fourth transistor T4 is connected to the second node N2, and a gate of the fourth transistor T4 is connected to the enable signal terminal EM. A first electrode of the fifth transistor T5 is connected to the third node N3, a second electrode of the fifth transistor T5 is connected to an anode of the light emitting device 130, and a gate of the fifth transistor T5 is connected to the enable signal terminal EM.

The first reset sub-circuit 70 includes a sixth transistor T6, a first electrode of the sixth transistor T6 is connected to the first reset signal terminal V1, a second electrode of the sixth transistor T6 is connected to the fourth node N4, and a gate of the sixth transistor T6 is connected to the fourth scan signal terminal G4.

The second reset sub-circuit 80 includes a seventh transistor T7, a first electrode of the seventh transistor T7 is connected to the second reset signal terminal V2, a second electrode of the seventh transistor T7 is connected to a second electrode of the light emitting device 130, and a gate of the seventh transistor T7 is connected to the fifth scan signal terminal G5.

One luminous period of the light emitting device 130 includes the pre-write phase, the write phase and the luminous phase. The pre-write phase may include the first frame in FIG. 8, the write phase may include the second frame and the third frame in FIG. 8, and the luminous phase may include the fourth frame in FIG. 8.

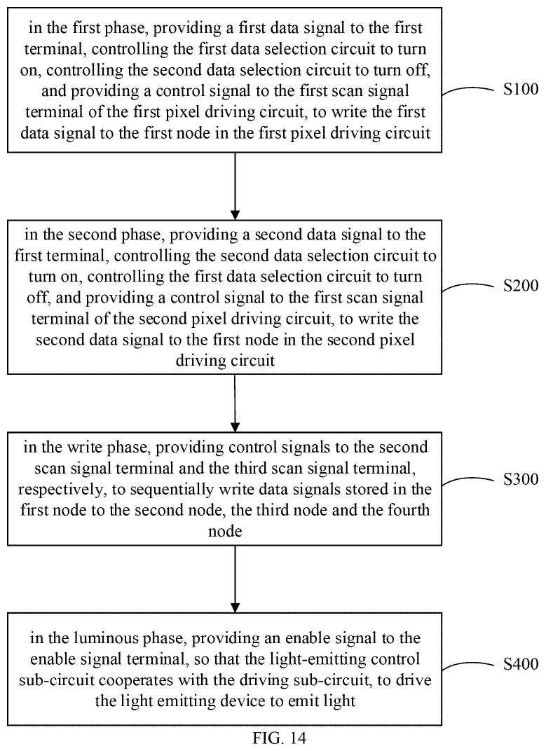

FIG. 14 is a flow chart of a control method of a display panel disclosed according to the present disclosure. As shown in FIG. 14, the control method of the display panel includes the following steps.
Step S100, in the first phase, providing a first data signal to the first terminal, controlling the first data selection circuit to turn on, controlling the second data selection circuit to turn off, and providing a control signal to the first scan signal terminal of the first pixel driving circuit, to write the first data signal to the first node in the first pixel driving circuit.

The first data selection circuit is turned on, to enable the first data signal received by the first terminal to be input into the first data line, while the second data selection circuit is turned off, preventing signals from being input into the second data line. After providing the control signal to the first scan signal terminal of the first pixel driving circuit, the data temporary storage sub-circuit in the first pixel driving circuit conducts, so that the first data signal in the first data line is written to the first node in the first pixel driving circuit.
Step S200, in the second phase, providing a second data signal to the first terminal, controlling the second data selection circuit to turn on, controlling the first data selection circuit to turn off, and providing a control signal to the first scan signal terminal of the second pixel driving circuit, to write the second data signal to the first node in the second pixel driving circuit.

The second data selection circuit is turned on, to enable the second data signal to be input into the second data line through the first terminal, while the first data selection circuit is turned off, preventing signals from being input into the first data line. After providing the control signal to the first scan signal terminal of the second pixel driving circuit, the data temporary storage sub-circuit in the second pixel driving circuit conducts, so that the second data signal in the second data line is written to the first node in the second pixel driving circuit.
Step S300, in the write phase, providing control signals to the second scan signal terminal and the third scan signal terminal, respectively, to sequentially write data signals stored in the first node to the second node, the third node and the fourth node.

Providing the control signals to the second scan signal terminal and the third scan signal terminal respectively includes: providing the control signals to the second scan signal terminal and the third scan signal terminal in the first pixel driving circuit, and providing the control signals to the second scan signal terminal and the third scan signal terminal in the second pixel driving circuit, respectively. Among them, the first pixel driving circuit and the second pixel driving circuit can receive the control signals simultaneously or in sequence, and which is not limited in this embodiment of the present disclosure.

For example, the first pixel driving circuit and the second pixel driving circuit simultaneously receive the control signals. For example, the second scan signal terminal and the third scan signal terminal of the first pixel driving circuit, as well as the second scan signal terminal and the third scan signal terminal of the second pixel driving circuit, are all connected to the same gating line.
Step S400, in the luminous phase, providing an enable signal to the enable signal terminal, so that the light-emitting control sub-circuit cooperates with the driving sub-circuit, to drive the light emitting device to emit light.

In the pixel driving circuit and display panel provided in the embodiments of the present disclosure, the light emitting device connected to the first pixel driving circuit is the first light emitting device, and the light emitting device connected to the second pixel driving circuit is the second light emitting device. When controlling the first light emitting device and the second light emitting device to emit light, the first data selection circuit for writing data signals to the first pixel driving circuit and the second data selection circuit for writing data signals to the second pixel driving circuit are turned on within one frame range, while the write sub-circuits in the first pixel driving circuit and the second pixel driving circuit conduct within another frame range. That is, the turn-on of the data selection circuit and the conduction of the write sub-circuit are in two different frames, respectively. Compared to the solution in the related art that the turn-on of the data selection circuit and the conduction of the write sub-circuit are in the same frame range, the turn-on time of the data selection circuit and the conduction time of the write sub-circuit are significantly increased in the present disclosure.

The above described device embodiments are only illustrative, where the units described as separate components may or may not be physically separated, and the components displayed as units may or may not be physical units, that is, they can be located in one place or distributed across multiple network units. Some or all of the modules can be selected according to actual needs to achieve the purpose of this embodiment. Persons skilled in the art can understand and implement without creative effort.

The term “one embodiment”, “an embodiment” or “one or more embodiments” referred to in this specification means that specific features, structures or characteristics described in conjunction with the embodiments are included in at least one embodiment disclosed herein. Furthermore, please note that the word “in one embodiment” may not necessarily refer to the same embodiment.

In the specification provided here, a large number of specific details are explained. However, it can be understood that the embodiments of the present disclosure can be practiced without these specific details. In some examples, well-known methods, structures, and techniques are not shown in detail to avoid blurring the understanding of this specification.

In the claims, any reference symbols located between parentheses should not be constructed as limitations on the claims. The word “comprising” does not exclude the existence of elements or steps that are not listed in the claims. The word “a/an” or “one” before the component does not exclude the existence of multiple such components. The present disclosure can be implemented by means of hardware including several different components and by means of appropriately programmed computers. In the unit claims listing several devices, several of these devices may be specifically embodied through the same hardware item. The use of words such as first, second, and third does not indicate any order. These words can be interpreted as names.

Finally, it should be noted that the above embodiments are only used to illustrate the technical solution of the present disclosure and not to limit it. Although the present disclosure has been described in detail with reference to the aforementioned embodiments, those skilled in the art should understand that they can still modify the technical solutions described in the aforementioned embodiments, or equivalently replace some of the technical features. And these modifications or substitutions do not depart from the essence and scope of the corresponding technical solutions in the embodiments of the present disclosure.

1. A pixel driving circuit, comprising a driving sub-circuit, a data temporary storage sub-circuit, a write sub-circuit, a compensation sub-circuit and a light-emitting control sub-circuit; wherein
the data temporary storage sub-circuit is connected to a first node, a data signal terminal and a first scan signal terminal, and the data temporary storage sub-circuit is configured for, in a pre-write phase, storing a data signal from the data signal terminal at the first node in response to a control signal from the first scan signal terminal;
the write sub-circuit is connected to the first node, a second node and a second scan signal terminal, and the write sub-circuit is configured for, in a write phase, writing a signal of the first node to the second node in response to a control signal from the second scan signal terminal;
the driving sub-circuit is connected to the second node, a third node and a fourth node, and the driving sub-circuit is configured for, under a control of a potential at the fourth node, writing a signal of the second node to the third node;
the compensation sub-circuit is connected to the third node, the fourth node and a third scan signal terminal, and the compensation sub-circuit is configured for, in the write phase, writing a signal of the third node to the fourth node in response to a control signal from the third scan signal terminal: and
the light-emitting control sub-circuit is connected to a first voltage terminal, an enable signal terminal, the second node, the third node and a light emitting device, and the light-emitting control sub-circuit is configured for, in a luminous phase, cooperating with the driving sub-circuit to drive the light emitting device to emit light in response to an enable signal from the enable signal terminal.

2. The pixel driving circuit according to claim 1, wherein the data temporary storage sub-circuit comprises a first transistor and a first capacitor;
a gate of the first transistor is connected to the first scan signal terminal, a first electrode of the first transistor is connected to the data signal terminal, and a second electrode of the first transistor is connected to the first node; and
a first electrode plate of the first capacitor is connected to the first node.

3. The pixel driving circuit according to claim 2, wherein a second electrode plate of the first capacitor is connected to the first voltage terminal.

4. The pixel driving circuit according to claim 1, wherein the pixel driving circuit further comprises a storage sub-circuit, the storage sub-circuit is connected to the first voltage terminal and the fourth node, and the storage sub-circuit is configured for storing a signal of the fourth node.

5. The pixel driving circuit according to claim 4, wherein the storage sub-circuit comprises a second capacitor, a first electrode plate of the second capacitor is connected to the fourth node, a second electrode plate of the second capacitor is connected to the first voltage terminal.

6. The pixel driving circuit according to claim 1, wherein the driving sub-circuit comprises a driving transistor, a first electrode of the driving transistor is connected to the second node, a second electrode of the driving transistor is connected to the third node, and a gate of the driving transistor is connected to the fourth node.

7. The pixel driving circuit according to claim 1, wherein the write sub-circuit comprises a second transistor, a first electrode of the second transistor is connected to the first node, a second electrode of the second transistor is connected to the second node, and a gate of the second transistor is connected to the second scan signal terminal.

8. The pixel driving circuit according to claim 1, wherein the compensation sub-circuit comprises a third transistor, a first electrode of the third transistor is connected to the third node, a second electrode of the third transistor is connected to the fourth node, and a gate of the third transistor is connected to the third scan signal terminal.

9. The pixel driving circuit according to claim 1, wherein the light-emitting control sub-circuit comprises a fourth transistor and a fifth transistor;
a first electrode of the fourth transistor is connected to the first voltage terminal, a second electrode of the fourth transistor is connected to the second node, and a gate of the fourth transistor is connected to the enable signal terminal; and
a first electrode of the fifth transistor is connected to the third node, a second electrode of the fifth transistor is connected to an anode of the light emitting device, and a gate of the fifth transistor is connected to the enable signal terminal.

10. The pixel driving circuit according to claim 1, wherein the pixel driving circuit further comprises a first reset sub-circuit, the first reset sub-circuit is connected to the fourth node, a first reset signal terminal and a fourth scan signal terminal, and the first reset sub-circuit is configured for writing a signal of the first reset signal terminal to the fourth node in response to a control signal from the fourth scan signal terminal.

11. The pixel driving circuit according to claim 10, wherein the first reset sub-circuit comprises a sixth transistor, a first electrode of the sixth transistor is connected to the first reset signal terminal, a second electrode of the sixth transistor is connected to the fourth node, and a gate of the sixth transistor is connected to the fourth scan signal terminal.

12. The pixel driving circuit according to claim 1, wherein the pixel driving circuit further comprises a second reset sub-circuit, the second reset sub-circuit is connected to an anode of the light emitting device, a second reset signal terminal and a fifth scan signal terminal, and the second reset sub-circuit is configured for writing a signal of the second reset signal terminal to the light emitting device in response to a control signal from the fifth scan signal terminal.

13. The pixel driving circuit according to claim 12, wherein the second reset sub-circuit comprises a seventh transistor, a first electrode of the seventh transistor is connected to the second reset signal terminal, a second electrode of the seventh transistor is connected to a second electrode of the light emitting device, and a gate of the seventh transistor is connected to the fifth scan signal terminal.

14. A display panel, comprising a substrate, a plurality of pixel driving circuits according to claim 1 that are disposed on the substrate, and a light emitting device connected to the plurality of pixel driving circuits; the plurality of pixel driving circuits comprises a first pixel driving circuit and a second pixel driving circuit, and the display panel further comprises a first terminal, a first data selection circuit, a second data selection circuit, a first data line and a second data line;
the first terminal is connected to the first data selection circuit and the second data selection circuit, the first data selection circuit is connected to the first data line, the second data selection circuit is connected to the second data line, the first data line is connected to a data signal terminal of the first pixel driving circuit, and the second data line is connected to a data signal terminal of the second pixel driving circuit.

15. A control method of a display panel, for controlling the display panel according to claim 14, wherein one luminous period of the light emitting device comprises the pre-write phase, the write phase and the luminous phase, the pre-write phase comprises a first phase and a second phase, and the method comprises:
in the first phase, providing a first data signal to the first terminal, controlling the first data selection circuit to turn on, controlling the second data selection circuit to turn off, and providing a control signal to the first scan signal terminal of the first pixel driving circuit, to write the first data signal to the first node in the first pixel driving circuit;
in the second phase, providing a second data signal to the first terminal, controlling the second data selection circuit to turn on, controlling the first data selection circuit to turn off, and providing a control signal to the first scan signal terminal of the second pixel driving circuit, to write the second data signal to the first node in the second pixel driving circuit;
in the write phase, providing control signals to the second scan signal terminal and the third scan signal terminal, respectively, to sequentially write data signals stored in the first node to the second node, the third node and the fourth node; and
in the luminous phase, providing an enable signal to the enable signal terminal, so that the light-emitting control sub-circuit cooperates with the driving sub-circuit, to drive the light emitting device to emit light.

16. The display panel according to claim 14, wherein the data temporary storage sub-circuit comprises a first transistor and a first capacitor;
a gate of the first transistor is connected to the first scan signal terminal, a first electrode of the first transistor is connected to the data signal terminal, and a second electrode of the first transistor is connected to the first node; and
a first electrode plate of the first capacitor is connected to the first node.

17. The display panel according to claim 16, wherein a second electrode plate of the first capacitor is connected to the first voltage terminal.

18. The display panel according to claim 14, wherein each of the plurality of pixel driving circuits further comprises a storage sub-circuit, the storage sub-circuit is connected to the first voltage terminal and the fourth node, and the storage sub-circuit is configured for storing a signal of the fourth node.

19. The display panel according to claim 18, wherein the storage sub-circuit comprises a second capacitor, a first electrode plate of the second capacitor is connected to the fourth node, a second electrode plate of the second capacitor is connected to the first voltage terminal.

20. The display panel according to claim 14, wherein the driving sub-circuit comprises a driving transistor, a first electrode of the driving transistor is connected to the second node, a second electrode of the driving transistor is connected to the third node, and a gate of the driving transistor is connected to the fourth node.
